(19) United States
(12) Patent Application Publication
(10) Pub. No.: US 2006/0005143 A1
(43) Pub. Date: Jan. 5, 2006

(54) Method for managing media files, an electronic device utilizing the method and a computer program implementing the method

(75) Inventors: Johanna Sakkinen, Oulu (FI); Minna Karukka, Oulu (FI); Mika P. Mustonen, Ii (FI); Markku Rytivaara, Oulu (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/170,048

(22) Filed: Jun. 28, 2005

(30) Foreign Application Priority Data
Jun. 30, 2004 (FI) 20040906

(51) Int. Cl. G06F 3/00

(52) U.S. Cl. 715/772; 715/860

(57) ABSTRACT

The invention relates to a method for classifying a file to be saved in a mobile terminal device, in which method a visible visual identifier is added to the file information of the media record. The visual identifier describing the classification is visible always when the file identifier is on the display of the terminal device. The invention also relates to a terminal device utilizing the method and a computer program that can be saved in the terminal device.

### FIELD OF THE INVENTION

The invention relates to a method for classifying files to be saved in a mobile terminal device, in which classification method a visible visual identifier (tag) is added to the file information. The invention also relates to a terminal device utilizing the method and a computer program that can be saved in the terminal device.

### BACKGROUND OF THE INVENTION

To an increasing extent, data processing performed by people is taking place in electronic devices carried along by the user. Examples of such devices are terminal devices operating in some cellular network and PDAs (Personal Digital Assistant). Their physical size has been made as small as possible in order to make them easy to carry along. However, the small size entails problems that make it more difficult to use these devices.

Along with the development of the memory technology, the size of semiconductor memories has grown rapidly. No restrictions to the growth of the memory size are expected in the near future. Due to the grown memory capacity, it has been possible to utilize applications with increasing memory capacity requirements in mobile data processing devices. For example, it is already possible to save files of several megabytes in a terminal device of a cellular network. Memories like this can thus be used for saving high resolution images or video clips, media files, the contents of which can be briefly described by text-form qualifiers, file information. These qualifiers describing the saved file are generally called metadata.

However, the display of the devices and the interface in them become relatively small because of the physical size of the devices. Thus it is possible to process only a limited amount of information at a time in the display of the terminal devices of the cellular network. If there is a large number of files and their text qualifiers, the file qualifiers to be managed must be brought to the display of the terminal device in small parts. However, this impairs the overall manageability of the information. In the prior art devices, it is difficult to work out which other file saved in the same device earlier or which context the record being dealt with relates to.

### SUMMARY OF THE INVENTION

It is an objective of the invention to present a method and a device arrangement, by the utilization of which the user of a mobile terminal device can attach visual identifiers to various records, such as media records, to facilitate the classification of the files and the perception of the unity formed by the files. The visual identifiers according to the invention describe a larger group of records or some context to which the user considers the record being processed to belong.

The objectives of the invention are achieved by a procedure in which a visual identifier is attached to the file information of a record on the display of the terminal device. For each visual identifier according to the invention, the user can define what he wants to describe by it. The visual identifier can be attached by a function according to the invention, added to the menus of the terminal device, which the user can select in the ordinary manner from a menu used in the terminal device. When the visual identifier has been added, it remains in the record for a length of time defined by the user.

The invention has the advantage that a visual identifier can be attached to a file to be saved in an electronic device, specifying to which factual context the file being dealt with belongs or what other files it is connected with. Especially in devices in which the size of the display is limited, the classification and managing of saved files can be made considerably easier by means of a visual identifier.

Furthermore, the invention has the advantage that the shape, colour, patterning or size of the visual identifier can be utilized as a distinctive feature of the identifier.

In addition, the invention has the advantage that the user can modify the identifiers to be attached according to need.

The method according to the invention is characterized in that in the gallery view on the display of the terminal device:
a tag menu is selected from the Options submenu by tapping a tag menu icon on the touch screen
a classification criterion is selected from the opened tag menu, and along with it a visual identifier describing it, and
the selected visual identifier is attached to the file information of the file being dealt with, and the visual identifier is always visible in connection with the file information.

The terminal device according to the invention is characterized in that a menu of the gallery view on the display of the terminal device comprises means for attaching a visual identifier describing a classification criterion of the file to the file identifier, as a result of which the visual identifier is in sight when the file identifier is on the display of the terminal device.

A computer program product according to the invention for classifying files by utilizing a visual identifier in a terminal device of the cellular network is characterized in that it comprises
computer program means for adding the tag menu as a part of the Options sub-menu in the gallery view menu of the terminal device, or adding a tag menu icon on the touch screen
computer program means for creating and maintaining classification criteria in the tag menu
computer program means for associating a visual identifier with each classification criterion, and
computer program means for adding a visual identifier to a file selected in the gallery view menu.

Some preferred embodiments of the invention are presented in the dependent claims.

The basic idea of the invention is the following. A software application according to the invention has been saved in the mobile terminal device, and its functions are added as part of the menus belonging to the terminal device. By means of the software application, selection options can be added to the menus of the terminal device, by which selection options a visual identifier can be added to the file information of the files of the terminal device to facilitate the identification or classification of the file on the basis of the metadata describing the file, for example. The shape, colour, place or size of the identifier can be defined by the user. Similarly, the user can define what a certain visual identifier represents or to which group or context the files marked by a certain identifier belong. The user can utilize the identifiers according to the invention especially in the classification and sorting of media files in a terminal device. In sorting, media files having a certain identifier are grouped into one file group, and they can also be brought to the display of the device by groups.

### BRIEF DESCRIPTION OF THE DRAWINGS

In the following, the invention will be described in more detail. Reference will be made to the accompanying figures, in which

FIGS. 1a-1d show by way of example how the method according to the invention can be utilized in connection with an existing video record

FIGS. 2a-2d show by way of example how the method according to the invention can be utilized before making a video record

FIG. 3 is an exemplary flow chart showing how the method according to the invention is utilized in a terminal device of a cellular network, and

FIG. 4 shows the main parts of the terminal device according to the invention by way of example.

### DETAILED DESCRIPTION

In the following, the invention will be described in the light of examples, which relate to managing various media records in a terminal device of a cellular network, for example.

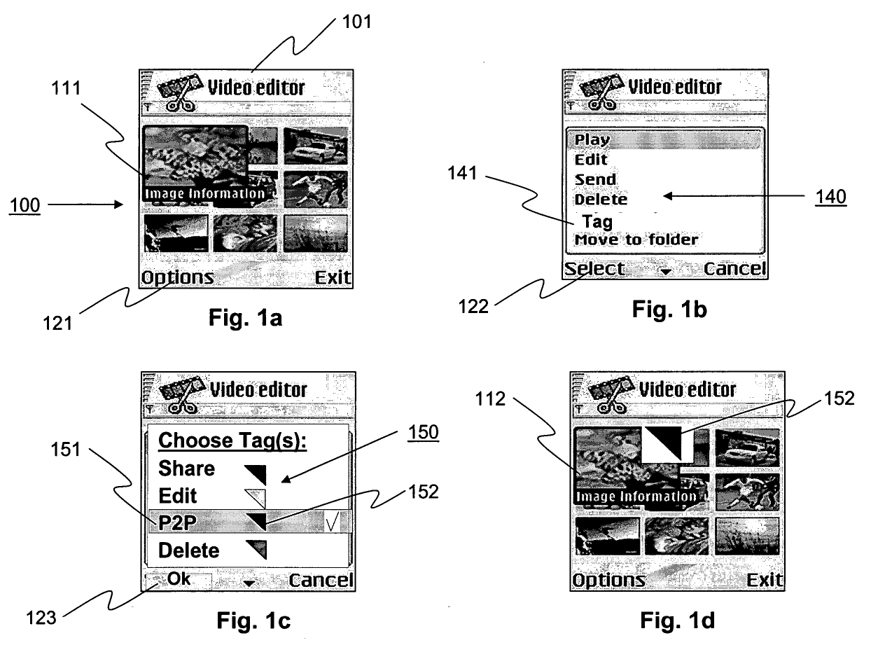

FIGS. 1a-1d show an example of how the method according to the invention can be utilized in connection with an existing media record. In the example of FIGS. 1a-1d, a visual identifier according to the invention is attached to an existing video clip.

In FIG. 1a, reference 100 denotes a prior art display of a terminal device of a cellular network. It can be a mere display or a touch-screen display, in which case it can also be used in the control commands of the terminal device. In the example of FIG. 1a, the application 101 used in the editing of videos is in the display 100. There is a plurality of icons on the display, which are related to the media files saved in the terminal device. The media record being processed is 111, which is also enlarged as compared to the other icons. There are also two menu keys at the lower edge of the display 100. By selecting “Options” 121, a menu saved in the terminal device is opened; this menu can be the so-called gallery view menu. By selecting “Exit”, the user can quit the video editing application.

If the user selects the alternative “Options” 121, a menu 140 of alternative measures according to FIG. 1b is opened on the display of the terminal device. In the example of FIG. 1b, the options of the prior art are found in the menu 140: Play, Edit, Send, Delete and Move to folder. It is obvious to a person skilled in the art that other alternative functions not presented in FIG. 1b can also be included in the list.

In addition to the prior art options, according to the invention the menu 140 also includes the option “Tag” 141, which is advantageously used for classifying the media file and for adding a visual identifier to the media file being processed. The user can move the cursor of the terminal device onto the desired option and make the selection by the selection key of the terminal device, which in the example of the figure is “Select” 122. When the “Select” button 122 is pressed, this selection option opens a tag menu 150 according to the invention, from which a suitable classification criterion and a related visual identifier can be selected for the media file being processed. If the user wants to exit the menu according to the invention, he/she can do it by using the Cancel key.

FIG. 1c shows a possible tag menu 150 by way of example. The tag menu 150 can naturally also comprise other alternatives than those shown in FIG. 1c. The user can thus add or remove selection options belonging to the tag menu 150. In the case of FIG. 1c, the user can select from the following options: Share, Edit, Peer-to-Peer Network (P2P) or Delete. According to the invention, each selection option available is also associated with a visual identifier 152. The visual identifier 152 can describe a media file e.g. by means of colour, shape, place, size or a combination thereof. In the example of FIG. 1c, colours are used for distinguishing between the identifiers (not visible in FIG. 1c). In the example of FIG. 1c, the user is about to select the option “Peer-to-Peer Network”, reference 151, because the cursor of the terminal device has been moved onto it. If the user presses the “OK” button 123, the visual identifier 152 of the peer-to-peer network is added to the media record 111 shown in FIG. 1a. The user can also exit this tag menu 150 by using the Cancel key.

FIG. 1d shows the situation when the OK button 123 has been pressed in the situation of FIG. 1c. The tag menu 150 is closed, and the icons shown in FIG. 1a are opened on the display 100 of the terminal device. However, the selected visual identifier 152 according to the invention has now also been attached to the icon 112 that was being processed, and this identifier is visible when the file identifier of the media record 112 is on the display of the terminal device. The media file classified by the method and marked by the identifier has preferably been joined as part of a file group in the terminal device. The classification options found in the tag menu 150 according to the invention have been used as the classification criterion.

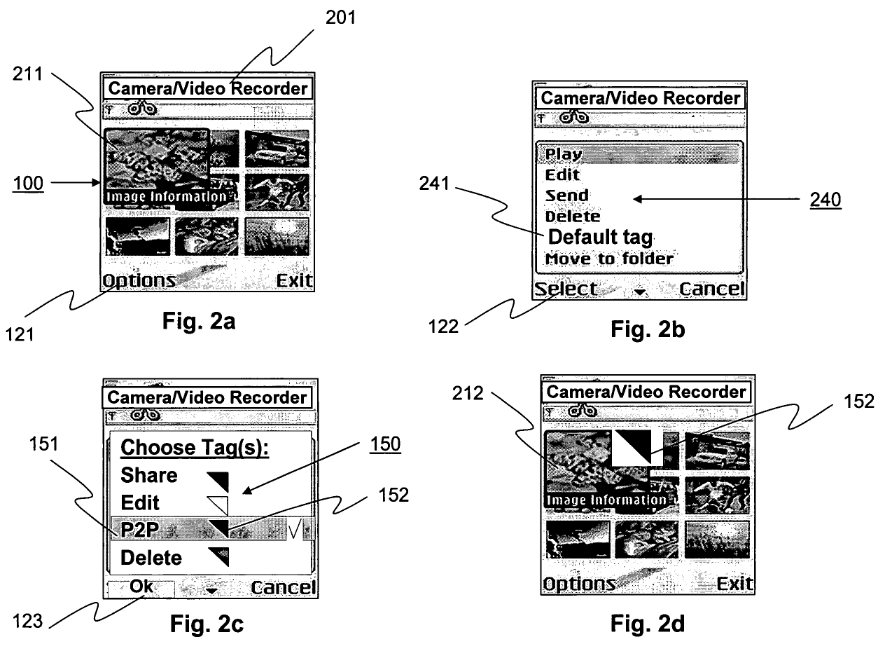

FIGS. 2a-2d show an example of how the method according to the invention can be utilized before making a media record. In the example of FIGS. 2a-2d, a visual identifier according to the invention is attached to a video clip being taken.

In FIG. 2a, reference 100 denotes a prior art display of a terminal device of a cellular network. In the example of FIG. 2a, the application 201 used in the recording of videos is in the display 100. There is a plurality of icons on the display, which are related to the media files saved in the terminal device. The video record icon 211 that is in focus is enlarged as compared to the other icons. There are also two menu keys at the lower edge of the display 100. The selection “Options” 121 opens a menu saved in the terminal device. By selecting “Exit”, the user can exit the video editing application.

If the user selects the alternative “Options” 121, a menu 240 of alternative measures according to FIG. 2b is opened on the display of the terminal device. In the example of FIG. 2b, the options of the prior art are found in the menu: Play, Edit, Send, Delete and Move to folder. It is obvious to a person skilled in the art that other alternative functions not presented in FIG. 2b can also be included in the menu. In addition to the prior art options, the menu 240 also includes the option “Default Tag” 241 according to the invention, which is used for adding a visual identifier to the video clip being taken.

When the button “Select” 122 is pressed, this selection option according to the invention opens a tag menu 150 according to the invention, from which a suitable classification criterion and a related visual identifier can be selected for the video clip being taken. If the user wants to exit the menu according to the invention, they can do it by using the Cancel key.

FIG. 2c shows a possible tag menu 150 as an example. The tag menu 150 can naturally also comprise other alternatives than those shown in FIG. 2c. The user can thus add or remove selection options belonging to the tag menu 150. In the example of FIG. 2c, the user can select from the following options: Share, Edit, Peer-to-Peer Network (P2P) or Delete. According to the invention, a visual identifier 152 described earlier is also associated with each selection option available.

In the example of FIG. 2c, the user is about to select the option “Peer-to-Peer Network” 151, because the cursor of the terminal device has been moved onto it. If the user presses the “OK” button 123, the visual identifier 152 of the peer-to-peer network is added to the video record 211 being made. The user can also exit this tag menu 150 by using the Cancel key.

FIG. 2d shows the situation when the OK button 123 has been pressed in the situation of FIG. 2c. The tag menu 150 is closed, and the file information shown in FIG. 2a is opened on the display 100 of the terminal device; in this case the icons are visible. However, the selected visual identifier 152 has now also been added to the icon 212 of the video clip being taken, the identifier of which is visible when the icon of the record is on the display 100 of the terminal device.

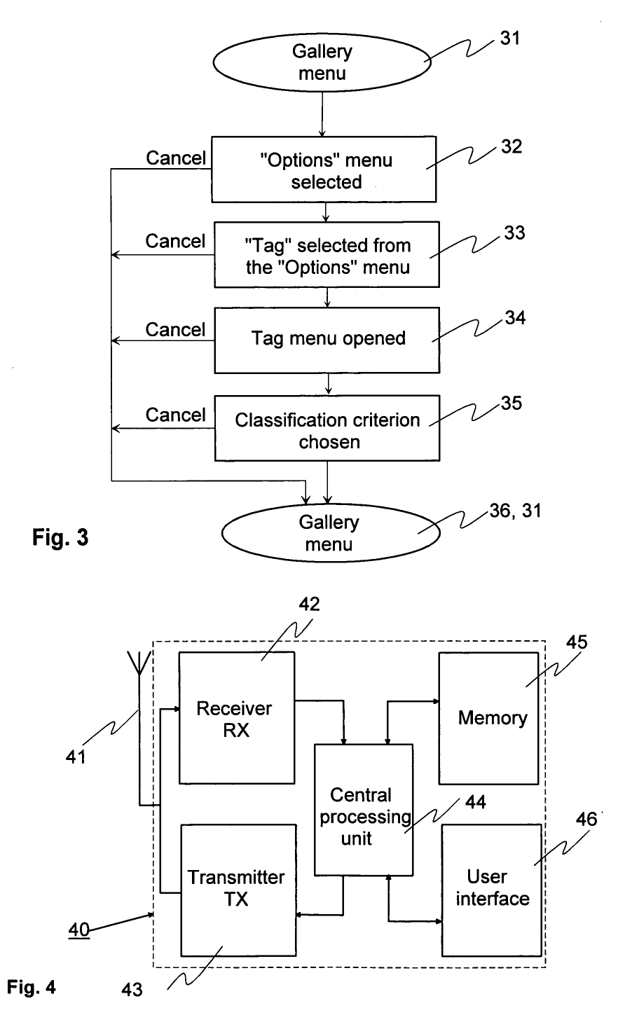

The main steps of the method according to the invention in connection with the processing of a media record are presented as an exemplary flow chart in FIG. 3. A prior art gallery view menu, to which the additional menus needed in the method according to the invention have been added, is available in a terminal device of the cellular network. The gallery view menu is opened in step 31. When the menu has been opened, it is used to select a media file to which the visual identifier according to the invention is to be added.

After this, in step 32, the Options submenu is selected from the gallery view menu. An option, reference 141 or 241, that enables selecting the tag menu 150 according to the invention, has been added to this Options submenu, references 140 or 240, in the terminal device. The option according to the invention is selected in step 33. In step 34, the selection made opens a tag menu 150 according to the invention, which preferably comprises selection options/classification criteria and visual identifiers presented in connection with FIGS. 1a-2d.

A suitable classification criterion and along with it a certain visual identifier are selected in step 35. The selected visual identifier is added to the media file being processed, and the terminal device returns to the gallery view menu, step 36 (starting step 31).

The user has been given the possibility to leave the process of adding a visual identifier during any of the steps 32 to 35 described above. Leaving is possible by means of the option “Cancel”.

FIG. 4 shows, by way of example, the functional main parts of a terminal device 40 of a cellular network capable of utilizing the method according to the invention. The terminal device can be, for example, a prior art GSM, GPRS or UMTS terminal device.

The terminal device 40 uses an antenna 41 in the transmission and reception of signals with the serving cellular network. The receiver means RX of the terminal device 40 are shown by reference 42. The receiver RX comprises prior art means for all messages or signals to be received.

Reference 43 denotes the means of which the transmitter TX of the terminal device 40 is composed. All the signal processing measures required when operating with a cellular network are performed on the signal to be transmitted by the transmitter means 43.

In the terminal device 40, the essential parts with regard to the utilization of the invention are the central processing unit 44 that controls its operation and the memory 45, in which the software application required in the implementation of the method for attaching a visual identifier according to the invention has advantageously been saved. The identifier options possible for the user with their visual differences can also be saved in the memory 45. When required, the user can also add or change the selectable identifiers by the program.

When operating in a prior art cellular network, such as the GSM network, the terminal device 40 also requires a SIM card (not shown in FIG. 4) in order to function. Each terminal device 40 can be uniquely identified by means of the information of the SIM card. Naturally, the program application according to the invention can also be saved on the SIM card instead of the memory 45 of the actual terminal device.

The central processing unit 44 controls the procedure of sorting the media files and attaching tags to them according to the invention. In this work it utilizes, for example, a program application according to the invention in the memory 45 and the tags saved in it.

The terminal device 40 also comprises a user interface 46. It comprises at least a display 100 and keyboard functions (not shown in FIG. 4). In the method according to the invention, different menus, media records to be processed or their file information are shown on the display 100. The visual identifiers according to the invention can be attached to the media records by means of functions added to the tag menu.

Some advantageous embodiments of the method and the terminal device according to the invention have been described above. The invention is not limited to the solutions described above, but the inventive idea can be applied in numerous ways within the limits set by the claims.

1. A method for classifying a file to be saved in a mobile terminal device by means of a visual identifier added to the file information, in which method
the gallery view menu is opened on the display of the terminal device
the file to be processed is selected
the Options submenu is selected from the gallery view menu
an tag menu is selected from the Options submenu
a classification criterion is selected from the opened tag menu, and along with it a visual identifier describing it, and
the selected visual identifier is attached to the file information of the file being dealt with, and the visual identifier is always visible in connection with the file information.

2. The method according to claim 1 wherein the visual identifiers differ from each other in at least one of the following aspects: shape, place, colour, pattern or size.

3. The method according to claim 2 wherein the user defines the visual identifiers that belong to the classification criteria.

4. The method according to claim 1 wherein the file classification criteria comprises: Share, Edit, Peer-to-Peer Network or Delete.

5. The method according to claim 1 wherein the files to be classified are media files.

6. The method according to claim 1 wherein the metadata related to the file is described by a visual identifier.

7. A terminal device of a cellular network, which comprises a gallery view menu for processing files in the terminal device, where the gallery view menu also comprises means for attaching a visual identifier describing a file classification criterion to the file information, which visual identifier is visible when the file information is on the display of the terminal device.

8. The terminal device according to claim 7 wherein the means for attaching a visual identifier to the file information comprise
a tag menu selectable from the Options submenu
classification criteria selectable in the tag menu, and
a visual identifier attached to each classification criterion.

9. The terminal device according to claim 8 wherein the visual identifier is used to describe metadata related to the file.

10. The terminal device according to claim 7 wherein the file to be processed in the terminal device is a media file.

11. The terminal device according to claim 10 wherein the classification criteria comprise at least two of the following classification: Share, Edit, Peer-to-Peer Network or Delete.

12. The terminal device according to claim 11 wherein the visual identifiers attached to the classification criteria have been arranged to differ from each other in at least one of the following aspects: shape, place, colour, pattern or size.

13. The terminal device according to claim 12 wherein the user can modify the visual identifiers attached to the classification criteria or create new ones.

14. The terminal device according to claim 7 wherein the terminal is a terminal device of the GSM, GPRS or UMTS network.

15. A computer program product to be used in a terminal device of a cellular network in the classification of files by utilizing a visual identifier comprising,
computer program means for adding a tag menu as a part of the Options sub-menu in the gallery view menu of the terminal device
computer program means for creating and maintaining classification criteria in the tag menu
computer program means for attaching a visual identifier to each classification criterion, and
computer program means for adding a visual identifier to a file selected in the gallery view menu.

16. The computer program product according to claim 15 further comprising computer program means for classifying files on the basis of metadata attached to the files.

17. The computer program product according to claim 15 further comprising computer program means for classifying media files.

18. The computer program product according to claim 15 further comprising computer program means for creating the classification criteria Share, Edit, Peer-to-Peer Network or Delete of the tag menu.

19. The computer program product according to claim 15 further comprising computer program means for distinguishing the visual identifier of the file classification criterion from the others by at least one of the following aspects: shape, place, colour, pattern or size.

20. The computer program product according to claim 15 further comprising computer program means by which the user of the device can change the visual identifier belonging to the classification criterion to another one or create a new identifier.
